(19) United States
(12) Patent Application Publication
(10) Pub. No.: US 2024/0087058 A1
(43) Pub. Date: Mar. 14, 2024

(54) METHOD OF BUILDING A STRUCTURE

(71) Applicant: Morten Aleks Engel, Newton, MA (US)

(72) Inventor: Morten Aleks Engel, Newton, MA (US)

(21) Appl. No.: 18/239,716

(22) Filed: Aug. 29, 2023

Related U.S. Application Data
(60) Provisional application No. 63/405,771, filed on Sep. 12, 2022.

(51) Int. Cl. G06Q 50/08

(52) U.S. Cl. CPC G06Q 50/08

(57) ABSTRACT

A method of building a structure that corresponds to or represents a goal wherein the building of the structure directly corresponds to gains or achievements toward the goal, and individual components of the structure are added upon receipt of non-monetary contributions.

### CROSS-REFERENCE TO RELATED APPLICATION(S)

This application claims priority to, and the benefit of, co-pending U.S. Provisional Application 63/405,771, filed Sep. 12, 2022, for all subject matter common to both applications. The disclosure of said provisional application is hereby incorporated by reference in its entirety.

### FIELD OF THE INVENTION

The present invention relates to methods for building a structure. In particular, the present invention relates to a method of building a structure that corresponds to or represents a separate goal wherein the building of the structure directly corresponds to gains or achievements toward the separate goal.

### BACKGROUND

Human biology is complex, and most diseases stem from that complex biology gone awry. Indeed, very few diseases stem from a single genetic mutation. The genomic revolution has been moving relatively slowly because even comparing the full genome of a small group of sick people to healthy people rarely reveals obvious druggable targets. The key to unlocking biology is to develop a full biological picture of critical disease processes, which involves genomics, transcriptomics, proteomics, metabolomics, etc. followed over a period of time and tied to phenotypic and health outcomes. Such disease pathways have been successfully established in only relatively simple systems such as the blood clotting cascades (and thus the understanding of the impact of the various blood factors). The discernment of the biological pathways for most diseases is immature at best. Experts have argued that critical illness should be characterized by multi-omic fingerprints.

Machine learning and artificial intelligence are strong enablers for this quest; those algorithms are now relatively ubiquitous. However, structured multi-omics data sets from large numbers of people are required to enable these algorithms to be more useful and identify the key intervention points for disease progression and reversal.

Accordingly, there is a need to encourage or facilitate the collection of non-monetary contributions toward this goal, including genomic, transcriptomic, proteomic, metabolomic, etc. data followed over a period of time and tied to phenotypic and health outcomes of large numbers of individuals.

### SUMMARY

The method of the present invention provides a solution to the need for a structure that represents a goal, such as a humanitarian goal, where the actual construction of the structure directly corresponds to non-monetary contributions made toward the goal. One such goal is the formation of a collection or database of multi-omic data. The formation of such a collection or database is based on individuals contributing information about their physiology, genetics, and health to support the discovery of new treatments to prevent and cure disease on a global scale. The building of a structure reflecting the striving toward and achievement of a goal, wherein the construction of the structure is directly correlated to non-monetary contributions such as genetic and health data and/or physical samples (e.g., blood samples, stool samples, tumor samples, etc.), is intended to encourage individuals to provide such non-monetary contributions toward the goal.

In accordance with some embodiments, a method of building a physical structure is provided. The method involves receiving a contribution that is not monetary currency; and adding a component to the physical structure being built upon receipt of said contribution. Thus, for every predetermined unit of the contribution received, a predetermined unit of component is incorporated into the physical structure to advance the building of the physical structure.

The structure can be any suitable physical manifestation of the collection of the non-monetary contribution, including but not limited to a wall, seating structures such as multi-level bench structures, a house, a hospital, a maze, a pyramid, landscape features, etc. For example, the structure can be a pyramid wherein each brick in the pyramid corresponds with a contribution of, e.g., medical records, blood samples, stool samples, and/or medical images for the multi-omic database. The building unit can correspond to an individual sample (e.g., to a contributed blood sample) or to a contributing individual. The structure is constructed at a pace that relates to the non-monetary contributions received.

The structure and immediate surroundings can further act as a physical location for receiving non-monetary contributions. For example, the structure can serve as a collection site for biological samples. The structure may also serve as an education or awareness center for a particular goal. For example, the structure can serve to educate and provide awareness of the benefits of the creation of a multi-omic database. In certain embodiments, a website or portal is provided in conjunction with the building of the structure. The website or portal can provide a mechanism for collecting non-monetary contributions as well as provide education and awareness information about the humanitarian goal and the progress of the construction of the structure.

The structure may also serve as a beacon for attracting visitors and donations. For example, as the structure grows, it may become an interesting site to visit, which in turn could lead to further contributions.

In accordance with aspects of the present invention, the physical structure includes a geometric shape. In some such aspects, the physical structure includes a pyramid.

In accordance with aspects of the present invention, the contribution includes data. In some such aspects, the contribution includes human physiological data. In further aspects, the contribution includes human genetic data, human health data, or one or more of medical records, biological samples, and medical images. In still further aspects, the method further includes anonymizing data of the contribution.

In accordance with aspects of the present invention, the method further includes securely storing the contribution.

In accordance with aspects of the present invention, the method further includes providing the contribution for medical research purposes. In some such aspects, the contributor that contributes for medical research may further gain access or be provided with early medical treatment based on the medical research.

In accordance with aspects of the present invention, the method further includes building and maintaining at least one database or data store that stores data from the contribution.

In accordance with aspects of the present invention, the method further includes receiving a monetary contribution to pay for the component added into the physical structure being built.

In accordance with aspects of the present invention, the component includes an identifier with an identifying word, symbol, or phrase identifying a contributor of the contribution. In some such aspects, sections of the physical structure identify a contributor that has made multiple contributions.

In accordance with aspects of the present invention, the method further includes providing a collection site. In some such aspects, the collection site includes an online portal. In other aspects, the collection site includes one or more facilities at a location of the physical structure.

In accordance with aspects of the present invention, the method further includes providing a visitor center having information about the building of the physical structure. In some such aspects, the visitor center includes an online portal. In other aspects, the visitor center includes a facility at a location of the physical structure.

In accordance with aspects of the present invention, multiple physical structures can be built. In some such aspects, the multiple physical structures can be built in different geographic locations.

### BRIEF DESCRIPTION OF THE FIGURES

These and other characteristics of the present invention will be more fully understood by reference to the following detailed description in conjunction with the attached drawings, in which:

FIG. 1 is a flow diagram for building a structure in accordance with embodiments of the present invention;

FIG. 2 is an exemplary computing device used for promotion and education regarding the building of the structure and the collection, processing, and/or storage of contributions for the building of the structure, and

FIG. 3 is an example structure built using the method for building a structure in accordance with embodiments of the present invention.

### DETAILED DESCRIPTION

An illustrative embodiment of the present invention relates to a method of building a structure that corresponds to or represents a goal, such as a humanitarian goal, wherein the building of the structure directly corresponds to gains or achievements toward the goal.

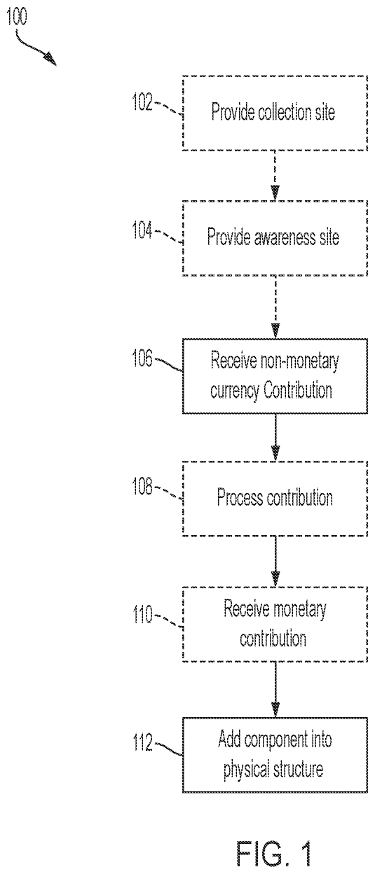

FIG. 1 through FIG. 3, wherein like parts are designated by like reference numerals throughout, illustrate an example embodiment or embodiments of the construction of a structure, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

FIG. 1 depicts a flow diagram providing a method 100 of constructing a structure in accordance with embodiments of the present invention. At the core of the method 100 are the steps of: receiving a contribution that is not monetary currency (step 106) and adding a component into the physical structure being built (step 112) wherein for every predetermined unit of the contribution received, a predetermined unit of component is incorporated into the physical structure to advance the building of the physical structure.

The structure can be any number of shapes, sizes, and configurations. In certain embodiments, the physical structure comprises a wall, a house, a hospital, one or more seating structures, a geometric shape, landscape features, decoration, or ornamentation, or the like. In some such embodiments, the physical structure comprises a pyramid. Other possible structures will be apparent to one skilled in the art given the benefit of this disclosure.

The contribution, which is not monetary currency, may comprise data. For example, the contribution may comprise human physiological data, human genetic data, and/or human health data. The contribution may also comprise one or more biological samples, including, but not limited to, a blood sample, a saliva sample, a stool sample, and a tissue sample. In some embodiments, the contribution comprises one or more of medical records and medical images. In some embodiments, the contribution can comprise a combination of one or more biological samples and one or more data aspects (e.g., genetic data, medical records, health data, phenotypic or disease data). In certain embodiments, contributors that provide contributions that go toward medical research can be provided with early access to medical treatment related to the medical research. Other possible incentives for contribution will be apparent to one skilled in the art given the benefit of this disclosure.

The unit of component being added to construct the structure may be, for example, any unit of building material. For example, the component being added may be a brick, block, stone, log, piece of milled lumber, or another suitable unit of building material. The component may also be a plant, stone feature, or other landscaping component. Similarly, the unit of building material may be a decoration or ornamentation. In some embodiments, the component is provided with an identifier such as an inscription, plinth, or plaque with an identifying word, symbol, or phrase identifying a contributor of the contribution. In still other embodiments, sections of structure could identify or be attributed to a contributor who has made multiple or significant contributions.

In certain embodiments, once a contribution is received it may be processed (Step 108). In some such embodiments, this can include one or more of: anonymizing data of the contribution, securely storing the contribution, building, and maintaining at least one database or data store that stores data from the contribution, and providing the contribution for medical research purposes.

In some embodiments, the method 100 may additionally include receiving a monetary contribution (step 110) to pay for the component added into the physical structure being built. However, the monetary contribution is not required. It is simply that the present method of constructing the structure as described herein does not preclude additionally receiving monetary contributions.

In certain embodiments, a collection site may be provided (step 102) to receive contributions. Similarly, a visitor center providing education and awareness may be provided (step 104). The sites may be online or physical sites. The online site can be an online portal or website. For example, the online collection site might be a portal or website where an individual can provide a contribution such as digital medical records. The online visitor center may be a portal or website providing information about the humanitarian goal, the building of the structure, and the status of construction. The physical site can be one or more facilities at or near the location of the structure. For example, the collection site could include one or more of a blood collection site, a stool and saliva (microbiome) collection site, a medical imaging site for physical scanning (MRI, CT, etc.), and a collection site for electronic records. The visitor center could include one or more of exhibits, a movie theater, and observation stations. In some embodiments, the portal or website can be accessed through a station or terminal located at the physical site, e.g., at the structure.

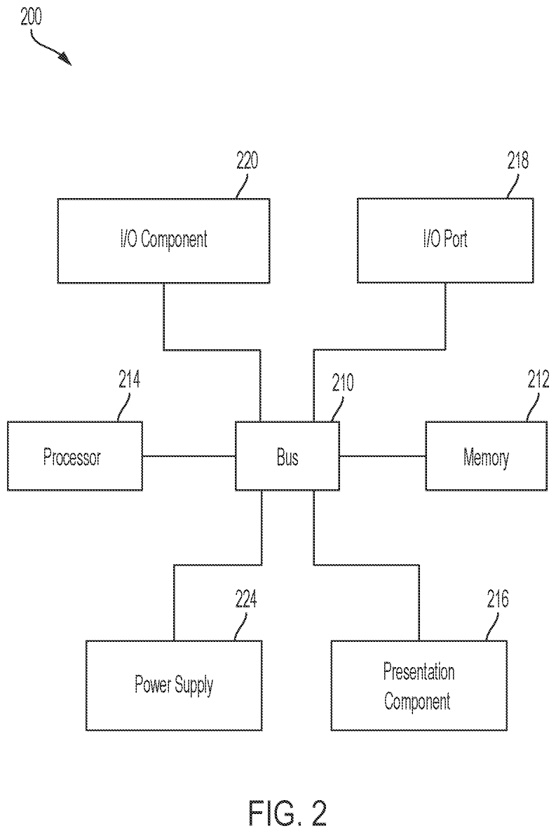

Any suitable and specifically configured electronic or computing device can be used to collect contributions, process contributions, and provide online collection and visitor center sites as described herein. One illustrative example of such an electronic or computing device 200 is depicted in FIG. 2. The computing device 200 is merely an illustrative example of a suitable computing environment and in no way limits the scope of the present invention. A “computing device,” as represented by FIG. 2, can include a “personal electronic device”, such as a “smartphone,” “smartwatch,” or “tablet,” a “workstation,” a “server,” a “laptop,” a “desktop,” or other specifically configured computing devices, as would be understood by those of skill in the art. Given that the computing device 200 is depicted for illustrative purposes, embodiments of the present invention may utilize any number of computing devices 200 in any number of different ways to implement a single embodiment of the present invention. Accordingly, embodiments of the present invention are not limited to a single computing device 200, as would be appreciated by one with skill in the art, nor are they limited to a single type of implementation or configuration of the example computing device 200.

The computing device 200 can include a bus 210 that can be coupled to one or more of the following illustrative components, directly or indirectly: a memory 212, one or more processors 214, one or more presentation components 216, input/output ports 218, input/output components, and a power supply 224.

One of skill in the art will appreciate that the bus 210 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 2 is merely illustrative of an exemplary computing device that can be used to implement one or more embodiments of the present invention, and in no way limits the invention.

The computing device 200 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 200.

The memory 212 can include computer-storage media in the form of volatile and/or nonvolatile memory. The memory 212 may be removable, non-removable, or any combination thereof. Exemplary hardware devices are devices such as hard drives, solid-state memory, optical-disc drives, and the like. The computing device 200 can include one or more processors that read data from components such as the memory 212, the various I/O components 220, etc. Presentation component(s) 216 present data indications to a user or other device. Exemplary presentation components include a display device, speaker, printing component, vibrating component, etc.

The I/O ports 218 can enable the computing device 200 to be logically coupled to other devices, such as I/O components 220. Some of the I/O components 220 can be built into the computing device 200. Examples of such I/O components 220 include a microphone, speakers, joystick, recording device, gamepad, satellite dish, scanner, printer, networking device, and the like.

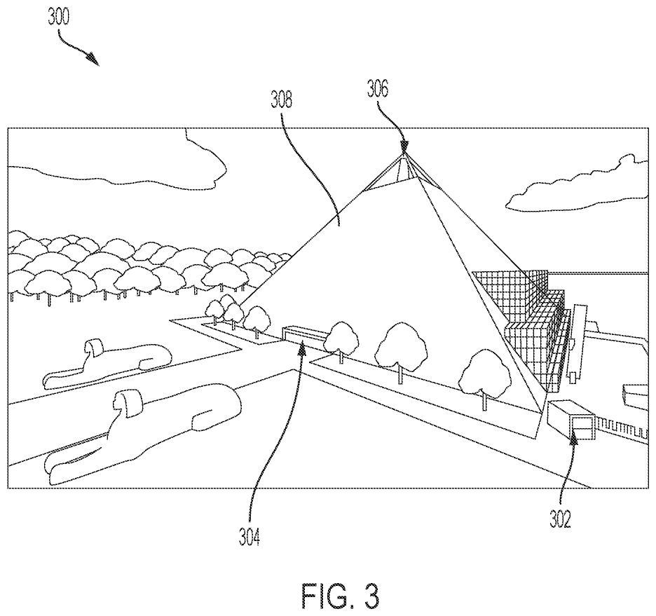

FIG. 3 depicts an example structure that can be built with the method of FIG. 1. Here the structure is a pyramid 300. The pyramid 300 enables people to contribute information about their physiology, genetics, and health to support the discovery of new drug targets, disease pathways, and/or new treatments to prevent and cure disease. The pyramid 300 is both a physical pyramid built out of bricks or stones 308 and an online platform where people may go to voluntarily donate their non-monetary contributions, such as electronic medical records, blood samples, stool samples, and/or medical images. The specimens collected are then sequenced and analyzed. All data can be anonymized, securely stored, and made available for medical research purposes.

Visitors to the site are encouraged to instantiate a brick 308, by making a non-monetary contribution, which can optionally be provided with an identifier such as being inscribed with the donor's name and laid on the pyramid 300. As such, the structure (e.g., pyramid 300) grows over time and visually represents the amount of data collected. In some embodiments, one structure for each major continent is contemplated. The structure (e.g., pyramid 300) can also serve as a destination where people and families may travel to have meaningful, educational, and even potentially spiritual common experiences.

An organization formed in support of the structure (e.g., pyramid 300) can make the anonymized data available to interested research organizations such as universities and biopharmaceutical companies to enable a search for cures to diseases and to improve the human condition.

In accordance with one embodiment, the structures may be built by crowdsourcing. Visitors each instantiate one brick 308, by making a non-monetary contribution, which is optionally laser-inscribed with the name of the contributor and placed on the pyramid 300. The land upon which the structure is built can be purchased by, e.g., a charitable or research organization in support of the endeavor. An area potentially larger than 100 hectares is envisioned to allow for the footprint of the pyramid 300, data collection buildings surrounding the pyramid, partner organizations, parking, etc.

Four information collection sites 302 can be positioned at the corners of the pyramid 300 embodiment of the structure: a blood collection site staffed by phlebotomists, a stool and saliva (microbiome) collection site, a medical imaging site for scanning (MRI, CT, etc.), and a collection site for electronic medical records are examples of function or operation of each of the sites 302.

In the center of the pyramid 300, according to an example embodiment, is a main visitor center 304, including exhibits, a movie theater, etc. This visitor center 304 is built first and bricks 308 are laid around and on top, eventually forming the shape of a four-sided pyramid 300. From the visitor center 304, there may be elevators to a top 306 of the pyramid 300, where there can be provided an observation platform. This platform will from time to time need to be raised as the pyramid 300 grows.

Surrounding the pyramid 300 on the surrounding campus, partner organizations such as research centers, patient organizations, spiritual organizations, and technology companies may establish themselves.

Multiple structures could also be built. In some such embodiment, the structures could be built in different locations. For example, structures could be built in different geographic areas to reflect the contributions of particular geographic areas.

All specimen samples can be analyzed (sequenced etc.) and the resulting data may be combined with all collected data (EMR etc.) and be cleaned, anonymized, formatted, and stored.

The organization can partner with technology providers such as sequencing manufacturers to provide cost-efficient solutions.

To any extent utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may exist in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extent or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method of building a physical structure, comprising:
receiving a contribution that is not monetary currency; and
adding a component into the physical structure being built;
wherein for every predetermined unit of the contribution received, a predetermined unit of component is incorporated into the physical structure to advance building of the physical structure.

2. The method of claim 1, wherein the physical structure comprises a geometric shape.

3. The method of claim 1, wherein the physical structure comprises a pyramid.

4. The method of claim 1, wherein the contribution comprises data.

5. The method of claim 1, wherein the contribution comprises human physiological data.

6. The method of claim 1, wherein the contribution comprises human genetic data.

7. The method of claim 1, wherein the contribution comprises human health data.

8. The method of claim 1, wherein the contribution comprises one or more of medical records, biological samples, and medical images.

9. The method of claim 1, further comprising anonymizing data of the contribution.

10. The method of claim 1, further comprising securely storing the contribution.

11. The method of claim 1, further comprising providing the contribution for medical research purposes.

12. The method of claim 11, further comprising giving a contributor of a contribution for medical research purposed early access to medical treatment.

13. The method of claim 1, further comprising building and maintaining at least one database or data store that stores data from the contribution.

14. The method of claim 1, further comprising receiving a monetary contribution to pay for the component added into the physical structure being built.

15. The method of claim 1, wherein the component includes an identifier with an identifying word, symbol, or phrase identifying a contributor of the contribution.

16. The method of claim 15, wherein sections of the physical structure identify a contributor that has made multiple contributions.

17. The method of claim 1, further comprising providing a collection site.

18. The method of claim 17, wherein the collection site comprises an online portal.

19. The method of claim 17, wherein the collection site comprises one or more facilities at a location of the physical structure.

20. The method of claim 1, further comprising providing a visitor center having information about the building of the physical structure.

21. The method of claim 20, wherein the visitor center comprises an online portal.

22. The method of claim 20, wherein the visitor center comprises a facility at a location of the physical structure.

23. The method of claim 1, wherein multiple physical structures are built.

24. The method of claim 23, wherein the multiple physical structures are located in different geographic locations.
